(19) United States
(12) Patent Application Publication
(10) Pub. No.: US 2007/0145626 A1
(43) Pub. Date: Jun. 28, 2007

(54) METHOD AND DEVICE FOR THE PRODUCTION OF PLASTIC PARTS BY MEANS OF PLATING

(75) Inventor: Hermann Bartels, Muhlheim (DE)

Correspondence Address: FOLEY AND LARDNER LLP;SUITE 500, 3000 K STREET NW, WASHINGTON, DC, 20007, US

(73) Assignee: ROCHLING AUTOMOTIVE AG & CO. KG

(21) Appl. No.: 11/559,098

(22) Filed: Nov. 13, 2006

(30) Foreign Application Priority Data
Nov. 11, 2005 (DE) 10 2005 053 823.1

(51) Int. Cl. B28B 7/42

(52) U.S. Cl. 264/85; 264/319; 425/508; 425/407; 425/DIG. 246; 425/384; 425/547

(57) ABSTRACT

A method for the production of plastic parts employs a galvano mold arranged in a rotatable housing. The galvano mold is heated to the melting temperature of a plastic by contact with an oil, and thereafter, the housing is reoriented so that the oil is collected underneath the galvano mold, and then it is removed from the housing to cool down the galvano mold. In the housing, the oil is blanketed by an inert gas, such as nitrogen, and the inert gas is introduced with overpressure into the housing, while the oil is simultaneously drawn from the housing into a storage tank having an inert gas atmosphere at a reduced pressure. The oil is heated again, as needed, and returned into the housing for the next production cycle.

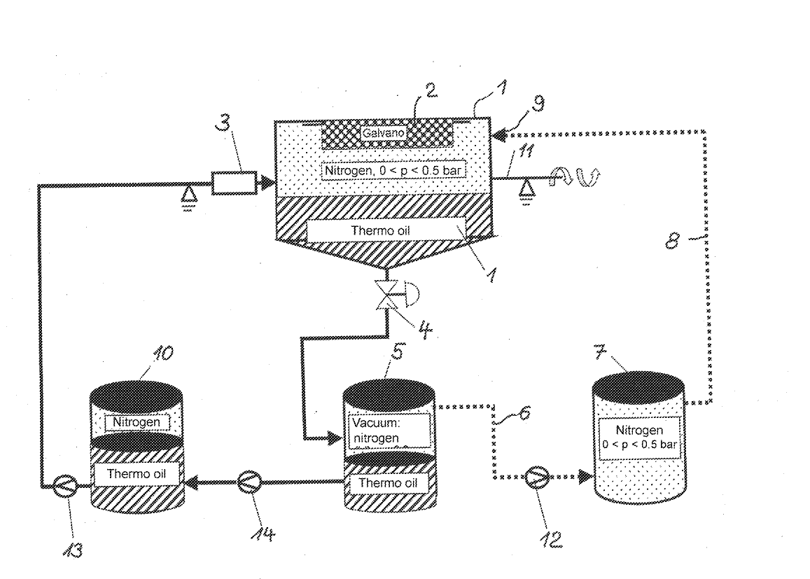

### CROSS-REFERENCE TO RELATED PATENT APPLICATIONS

The right of foreign priority is claimed under 35 U.S.C. § 119(a) based on Federal Republic of Germany Application No. 10 2005 053 823.1, filed Nov. 11, 2005, the entire contents of which, including the specification, drawings, claims and abstract, are incorporated herein by reference.

### BACKGROUND OF THE INVENTION

The present invention relates to a method and a device for the production of plastic (synthetic resin) parts by means of the galvano molding technique.

These methods use mostly metallic forms onto which a plastic powder is sprinkled and which are heated to the melting temperature of the plastic material. The powder melts thereby and assumes the form of the galvano mold. The galvano mold is heated, e.g., by means of a thermal transfer medium from the rear, e.g., with sand or with thermal oil. The present invention relates to the last named procedure, which has advantages in comparison to other methods. In particular, this method is faster and results in products with better dimensional stability. See, for example, DE 10 2004 062 589.1 (corresponding to U.S. 2002/079616 A1) and DE 100 47 318 C1, the entire contents of which are incorporated herein by reference.

Following the melting of the plastic powder, the molded products obtained must solidify for removal from the galvano mold, and for this reason the rate of cooling is of major importance with regard to cycle times.

### SUMMARY OF THE INVENTION

Accordingly, one object of the present invention is to provide a method and apparatus for accelerating the cooling of the galvano mold in a very simple manner, without substantially changing the housing surrounding the galvano mold.

In accordance with one aspect of the present invention, there is provided a method for producing a synthetic resin part by means of a galvano mold arranged in a housing, comprising: heating the galvano mold by contact with an oil to at least the melting temperature of the synthetic resin; thereafter reorienting the housing to displace the oil to a position away from the galvano mold; removing the oil from the housing by introducing into the housing an inert gas at an elevated pressure, and simultaneously drawing the oil from the housing by applying a reduced pressure at an oil outlet in the housing.

In accordance with another aspect of the invention, there is provided an device for carrying out the method according to the invention, comprising: a housing with a galvano mold provided therein; a device for introducing a synthetic resin powder from the outside and coating it on the inside of the mold; a passage for contacting the mold with hot thermal oil, to heat the mold; an inlet and an outlet in the housing for thermal oil; a gas inlet for supplying an inert gas to the housing; a first tank connected to the outlet for receiving the thermal oil and the inert gas withdrawn from the housing; an inert gas supply tank for supplying inert gas at an elevated pressure; and a line connecting the inert gas tank to the gas inlet of the housing.

Further objects, features and advantages of the present invention will become apparent from the detailed description of preferred embodiments that follows, when considered together with the accompanying FIGURE of drawing.

### BRIEF DESCRIPTION OF THE DRAWINGS

The invention will be explained in more detail by means of the enclosed FIGURE, which schematically illustrates the process and apparatus according to the invention.

### DETAILED DESCRIPTION OF THE PREFERRED EMBODIMENTS

The invention provides a method for the production of plastic parts by means of a galvano mold that is arranged in a rotatable housing and is heated, from its rear, to the melting temperature of the plastic by means of an oil. Thereafter, the housing is displaced, preferably by rotating, and the oil is collected underneath the galvano mold and removed from the housing to let the galvano mold cool down. In the housing, the oil is blanketed by an inert gas, such as nitrogen in one preferred embodiment. In accordance with the invention, the inert gas is preferably introduced with overpressure into the housing, and the oil is simultaneously drawn from the housing into a storage tank having an inert gas atmosphere, by means of the lower pressure of a (partial) vacuum prevailing there. The pressure of the inert gas introduced into the housing is greater than the pressure at the outlet of the housing, and preferably the pressure of the inert gas introduced is above atmospheric pressure. The oil is then heated again, as necessary, and returned into the housing for the next production cycle.

At temperatures of around 300° C., the heat content of the thermal oil is so high that especially the radiant heat emitted from the oil surface will significantly influence the cooling rate. Any attempts to accelerate the drainage of hot oil from the housing by means of pumps are not practical, for the reason that it is possible only with relatively major expenditures to thermally separate electric motors from the tank wall, which is also at approx. 300° C. Furthermore, these pumps cannot be allowed to run dry, since this would result in damage. Thus, a residual amount of oil of an unknown temperature would normally remain in the tank which, on the one hand, would prevent shorter cooling times for the reasons indicated above, and on the other hand, would also result in inhomogeneities during a renewed oil supply, which will result in quality losses in the temperature sensitive plastic working materials.

The method according to the invention which includes discharging the hot oil at simultaneous overpressure over the oil surface and a reduced pressure, ideally a vacuum, in the suction lines enables an increase in the drawing-off speed, with complete drainage, and thus also enables significantly shorter cycle times. It also ensures that the temperature distribution in the oil will be extremely uniform after the renewed supply of the oil to the mold.

Aside from enabling faster cycle times, the invention also offers the advantage that, due to the improved cooling, fewer plastic residues adhere to the galvano mold, which consequently does not need to be cleaned at all or considerably less often. Moreover, the dimensional stability of the products is also increased.

The drawn-off/pressed-off thermal oil is advantageously pumped via a thermal oil pump into a storage tank that also preferably has an inert gas, most preferably, e.g., nitrogen, atmosphere. It is kept here at the required temperature, and a required volume thereof will be returned again into the housing for the next cycle.

In the storage tank, the drawn-off hot thermal oil is also preferably blanketed with inert gas. It is preferred to carry out an inert gas cycle such that it is partly also exhausted from the housing and from there transferred into a separate storage tank for the inert gas, in which the inert gas is held at an elevated pressure.

In accordance with the invention, it is furthermore possible to pass inert gas through a cooler, which can be done directly or via a bypass, so that cooled inert gas will be admitted to the galvano mold while the thermal oil is drawn off at the same time, i.e., to further enhance cooling of the molded article produced. The cooled inert gas will preferably have a temperature corresponding to the temperature at which the molded article of the respective plastic material is to be removed from the mold.

The pressure differential for expelling the thermal oil from the housing can be varied widely. Particularly suitable for expelling the thermal oil is a pressure of 0<p<0.5 bar in the inert gas storage tank or, respectively, the housing and a pressure of −0.6<p<−0.3 bar in the tank into which the oil is drawn off.

Turning now to the FIGURE, housing 1 comprises the galvano mold 2, which is accessible from above for coating with plastic powder. Housing 1 contains an amount of thermal oil at a temperature of approx. 300° C., which is preferably blanketed with nitrogen to avoid oxidation. Housing 1 is preferably arranged on a rotary axis 11, and nitrogen is supplied via line 8.

When housing 1 is rotated by 180°, thermal oil comes into contact with the galvano mold 2 and heats it up, prior to the coating with plastic powder, for which it will be swiveled back into the position shown.

After coating the galvano mold, the oil is passed via valve 4 into the thermal oil tank 5, which also has a nitrogen atmosphere. In one preferred embodiment, an overpressure between +0 and +0.5 bar is applied on the side of housing 1, whereas the thermal oil tank 5 has a pressure between about −0.6 and −0.3 bar.

After discharging the thermal oil into the tank 5, entrained nitrogen also passes into tank 5 and is passed from there, via a vacuum pump 12, into the nitrogen tank 7, which is designed to achieve the desired overpressure. Tank 7 is connected via line 8 with the housing 1, through the inert gas connection 9.

The thermal oil is preferably transferred from the tank 5, via a first pump 14, into an intermediate tank 10, which is also blanketed with nitrogen. After any necessary heating that is optionally and preferably carried out in intermediate tank 10, the oil is passed back, via a second pump 13, into the housing 1 which has a rotary passage for it, serving as inlet 3. Compared with the conventional drainage of the housing 1, this process is considerably accelerated and results in faster cooling of the galvano mold 2.

It is also possible to optionally introduce into the housing a cooled nitrogen via the inert gas connection 9, for draining the housing 1 after the heating process, and for this purpose a bypass with a nitrogen cooler can be provided in line 8. Alternatively, a selectively actuatable cooler can be directly connected in line 8.

The foregoing description of preferred embodiments of the invention has been presented for purposes of illustration and description only. It is not intended to be exhaustive or to limit the invention to the precise form disclosed, and modifications and variations are possible and/or would be apparent in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and that the claims encompass all embodiments of the invention, including the disclosed embodiments and their equivalents.

What is claimed is:

1. A method for producing a synthetic resin part by means of a galvano mold arranged in a housing, comprising:
heating the galvano mold by contact with an oil to at least the melting temperature of the synthetic resin;
thereafter reorienting the housing to displace the oil to a position away from the galvano mold;
removing the oil from the housing by introducing into the housing an inert gas at an elevated pressure, and simultaneously drawing the oil from the housing by applying a reduced pressure at an oil outlet in the housing.

2. A method according to claim 1, wherein the oil is drawn off from the housing into a first tank that is at said reduced pressure, and further comprising optionally subjecting the oil to heating and returning the oil into the housing.

3. A method according to claim 2, further comprising transferring the oil from the first tank into a second tank, from which the oil is returned into the housing.

4. A method according to claim 2, wherein the first tank has an inert gas atmosphere therein.

5. A method according to claim 2, comprising drawing the inert gas along with the oil into the first tank, from there transferring the inert gas into a third tank, and form there passing the inert gas into the housing for expelling oil.

6. A method according to claim 1, wherein a pressure of between about 0 and 0.5 bar is applied in the housing for expelling the oil, and wherein said reduced pressure comprises a vacuum of about −0.6 to −0.3 bar.

7. A method according to claim 1, wherein the inert gas comprises nitrogen.

8. A method according to claim 1, further comprising cooling the inert gas before introducing the inert gas into the housing.

9. A device for carrying out the method according to claim 1, comprising a housing with a galvano mold provided therein, a device for introducing a synthetic resin powder from the outside and coating it on the inside of the mold;
a passage for contacting the mold with hot thermal oil, to heat the mold;
an inlet and an outlet in the housing for thermal oil;
a gas inlet for supplying an inert gas to the housing;
a first tank connected to the outlet for receiving the thermal oil and the inert gas withdrawn from the housing;
an inert gas supply tank for supplying inert gas at an elevated pressure; and
a line connecting the inert gas tank to the gas inlet of the housing.

10. A device according to claim 9, further comprising an intermediate tank arranged in a line for returning the thermal oil from the first tank to the housing.

11. A device according to claim 9, further comprising a device for producing an elevated pressure in the inert gas supply tank and a line connected from the first tank to the inert gas tank.

12. A device according to claim 9, further comprising a device for producing a reduced pressure in the first tank.

13. A device according to claim 10, further comprising a heater for heating the oil prior to returning the oil to the housing.
